(19) United States
(12) Patent Application Publication
(10) Pub. No.: US 2006/0146992 A1
(43) Pub. Date: Jul. 6, 2006

(54) System and method for real time monitoring an interactive voice response system

(75) Inventors: Jonathan Paden, Austin, TX (US); Scott Andrew Newman, Little Elm, TX (US); Bobby Sams, Austin, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/026,267

(22) Filed: Dec. 30, 2004

(51) Int. Cl. H04M 1/64

(52) U.S. Cl. 379/88.01

(57) ABSTRACT

The present invention provides a real-time system and method for monitoring an IVR system. An embedded IVR application monitors the IVR and sends a message in real time to an IVR client each time an IVR activity occurs. An IVR activity can be a receipt of a call or an input selection from a user, an IVR disconnect or another IVR action. The IVR application communicates in real time with the external client by sending and receiving messages in real time between the client and the IVR. The client also communicates with external systems that monitor IVR activity and apply business rules to the IVR activity. The business rules are applied to review the IVR activity to determine appropriate IVR responses and calculate network parameters such as a real time churn rate.

### BACKGROUND OF THE INVENTION

1. Field of the Invention

The present invention is related to the field of telecommunication networks and more particularly, to the field of real time monitoring of an interactive voice response (IVR) system in a telecommunication network.

2. Description of the Related Art

Interactive Voice Response (IVR) systems are used as service node platforms in a telecommunications network to provide enhanced call services in the telecommunications industry. The modern trend is to design and implement modular IVR service nodes that can be placed anywhere throughout a telecommunications network. It is common for a customer of a telecommunications service provider to use IVR services in conjunction with call center customer services including technical support. IVR service nodes are commonly used for customer call center routing to various customer service centers.

IVR service nodes can also perform other services such as automated servicing of customer calls, caller surveys, telemarketing, and call parking until a call center has an available resource (e.g., a live customer service agent). Internet users typically access the Internet through an Internet Service Provider (ISP), which provides users a connection to the Internet by establishing a communication link between a user's computer or telephone and a computing device operated by the ISP. An ISP has access to the Internet and can provide a remote dial server access ports for users to use in establishing connections via modem dial-up and high speed connections such as a digital subscriber line (DSL). Thus, ISP-provided access to the Internet is usually established by the user's dialing of one or more local-access telephone numbers and thereby establishing a communication link to the Internet over a phone line. Access services provided by an ISP can include Web hosting, email, VoIP (voice over IP), and support for many other applications.

An ISP customer user who experiences problems connecting to, or using, the Internet can report the problems to the user's ISP in alternative ways. To efficiently handle user reports of network problems, many ISPs utilize an IVR system. An IVR system provides an automated call handling system by which the user interacts with a computer-controller voice signal comprising either recorded real speech or computer-generated synthesized speech. The user's interaction with the IVR system of an ISP can be through the use of a touch tone telephone or through speech recognition. An automated reporting mechanism that ISPs use involves dial-up users leaving voice mail messages reporting details of a network problem encountered by a user.

ISPs or network operations centers (NOCs) associated with the ISP strive to promptly respond to IVR reported problems, such as network outages reported by users. The IVR is often monitored at the telephony network/toll free level or at the IVR level. In either case, an IVR monitoring report is usually periodically reported or written to a database. The telephony network level IVR monitoring report often provides a Call Data Record (CDR). The CDR usually contains a call in time at which a call is received at the IVR, a call in number from which the call into the IVR originated and a disconnect time at which the original call into the IVR is disconnected.

The CDRs are usually available after the IVR call has been disconnected and then reported after a prescribed reporting periodically, for example, every 5 to 15 minutes. In this case, there is at least a 5 minute delay after the original call into the IVR has disconnected before the toll free IVR monitoring report or CDR is received. In the case of IVR level monitoring reports, IVR statistics such as the number of sales IVR selections, technical support IVR selections, etc., are typically reported at the end of the day. In either case, at the network/toll free level or at the IVR level, the delay between receipt of the incoming IVR call and the IVR monitoring report can be too great to effectively respond to the incoming IVR call. Thus, there is a need for an IVR monitoring system that provides a timely opportunity to address IVR calls effectively.

### SUMMARY OF THE INVENTION

The present invention provides a real-time system and method for monitoring an IVR system. An embedded IVR application monitors the IVR and sends a message in real time to an IVR client each time an IVR activity occurs. An IVR activity can be a receipt of a call or an input selection from a user, an IVR output to a user or another IVR action. The IVR application communicates in real time with a client by sending and receiving IVR messages in real time between the client and the IVR. The client also communicates with external systems that monitor IVR activity and apply business rules to the IVR activity. The business rules are applied to review the IVR activity to determine appropriate IVR responses and calculate network parameters such as a real time churn rate of subscribers entering and leaving the network.

The present invention is extremely configurable and can operate independently of any other components, or in conjunction with other components as specified by the user. The present invention sends multiple IVR messages per call based on a caller's IVR selections or other IVR activity. In such cases the client can also return relevant data to the IVR which is specific to the caller's current actions within the IVR or address broader issues such as a network outage.

In one aspect of the invention, each call or contact to or from the IVR invokes a 2-way real time communication with the client. In this manner, the client is made aware substantially immediately in real time of IVR calls or contacts and IVR option selections or IVR actions as they occur. This enables the client application to drive any number of additional tools which can be valuable to an enterprise. Real time monitoring enables numerous advantages in analyzing and responding to IVR traffic and activity ascertained from the real time IVR messages.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

There are shown in the drawings, embodiments it being understood, however, that the invention is not limited to the precise arrangements and instrumentalities shown.

FIG. 1 is a schematic diagram of a communications network including a system and method according to one embodiment of the present invention;

FIG. 2 is a schematic diagram of one aspect of the system and method of the present invention;

FIG. 3 is a schematic diagram of another aspect the system and method of the present invention;

FIG. 4 is an example of an IVR message format including information contained in an IVR IN message;

FIG. 5 is an example of an IVR message format including information contained in an IVR IN Acknowledge Message;

FIG. 6 is an example of an IVR message format including information contained in an IVR OUT Message;

FIG. 7 is an example of an IVR message format including information contained in an IVR OUT Acknowledge; and

FIG. 8 is a flow chart of functions performed in an embodiment of the invention.

### DETAILED DESCRIPTION OF THE INVENTION

The present invention determines and reports in real time IVR calling parameters including but not limited to originating call location, the time at which the call came in to the IVR, IVR selections made by the caller, the number to which the IVR caller was redirected and type of disconnect from the IVR. Each of several hundred redirecting numbers at the IVR are associated with various network functions such as new service, billing, technical support, service cancellation and sales.

The system provides an early warning for possible network problems in real time, thereby enabling preemptive measures to be initiated by the system operator. For example if a report of a system outage message or report is received from an IVR caller or a system outage is otherwise detected, a system operator may insert an “ambush” in the IVR in response to the system outage. Thereby subsequent callers to the IVR will hear the ambush message on the IVR and be substantially appeased to the extent that they will not request to speak to a live operator. Thus, the ambush message alerts subsequent callers to the IVR of the outage and averts a flood of callers requesting live agent assistance during a network event such as the network outage. In a telecommunication system servicing hundreds of thousands of users, an ambush message call allay thousands of callers to the IVR without the expense of live operators answering the IVR callers. During peak periods, such as during an outage, IVR callers may be placed on hold for a long time while waiting to speak to an agent. The ambush message helps to alleviate customer frustration during an outage by quickly informing the IVR caller of the outage while avoiding long hold time waiting for a live customer service agent.

The present invention provides business rules that monitor and evaluate the IVR calls, activity and selections and locations from which calls originate to detect and localize IVR reported or IVR message related events. The programmable business rules are programmed or created by the network operator and can be used for, but not limited to, correlating user responses to network advertising and detecting network events such as network outages and IVR problems. The present invention provides for calculations of network parameters from IVR activity such as real time churn rate. Real time chum rate is calculated by subtracting IVR selections requesting new service from IVR selections requesting service disconnect. The real time churn rate or real time disconnect rate can correlated with network outages based on the real time IVR activities. A peak in requests to disconnect can be correlated with a network outage to penalize a carrier contracted to provide service to the disconnecting callers.

Another example of a network parameter and business rule is monitoring caller IVR selections via IVR messages to determine an appropriate response. For example, during an IVR session, a caller calls into the IVR and selects an IVR selection for “Technical Support” and then selects an IVR selection for a “Connection Problem”, then listens to a network outage message, subsequently backs out of “Technical Support” and selects an IVR selection for “Billing”. In this instance a business rule may assume, based on the sequence of IVR selections that the caller is requesting a “Service Outage Credit Request”. The business rule would indicate that the client would return a response to the IVR specifying a unique treatment where such a condition is expected. The present invention may also determine an ambush message success rate. The present invention can determine from monitored IVR activities and messages when an external client message such as an ambush message is heard by an IVR caller, after which the IVR caller voluntarily disconnects, rather than requesting a live agent. This scenario indicates that the ambush message successfully answered the caller's concerns without having the caller request live assistance. This enables the business rule to determine the real time ambush message success rate or effectiveness rate.

Additionally, a network-user device that is used for calling into an IVR can be correlated to a particular network device or location via, for example, an automatic number identification (ANI) or e-mail domain name. Therefore, real time tracking of the IVR contacts and activities further serves as an early warning of undetected network or IVR problems. This early warning allows the network service providers an opportunity to identify and locate a particular network event, activity or problem that appears to be occurring or developing. For example, aberrant IVR activity such as an inordinately high number of IVR disconnects and reattempts can be detected by an appropriate business rule programmed to detected an IVR problem. In addition an IVR caller reporting a network problem may alert a network provider of a yet undetected network outage. The early warning provides an opportunity for a network operator to react to a problem before the network operator has otherwise become aware of the problem or network event. Addressing the problem early reduces customer frustration and request to cancel service.

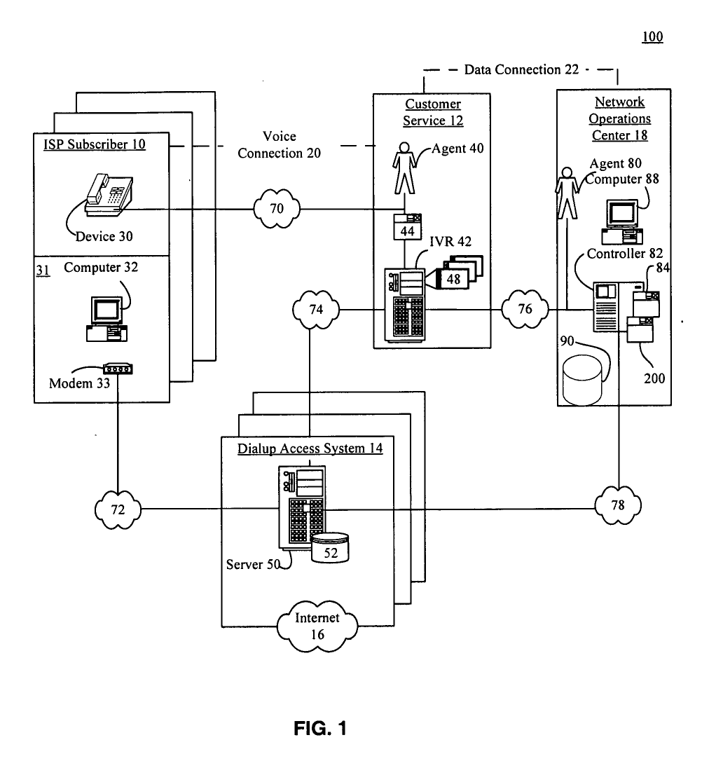

FIG. 1 is a schematic diagram illustrating elements of a data communication network 100 in which a system according to the present invention can advantageously be used for monitoring IVR contacts, selections and activities in real time. The network 100 is only one example of a system including an ISP in which the present invention is useful. The present invention is useful in any system providing an IVR including but not limited to a IVR call center for a water company, a cable television system, an electric utility or any other service. The network 100 illustratively includes an ISP, defining a network service provider, and a plurality of network users 10, illustratively comprising ISP subscribers. As illustrated, the network 100 further includes an ISP-operated customer service center 12, a network reliability center (NRC) or NOC 18 where the network is monitored by the ISP, and a dialup access system 14.

The dialup access system 14 can grant Internet 16 access to the ISP subscribers or network users 10. A network user 10 communicates via a telephone 30 or network-user device 31 that illustratively comprises a computer 32 that attaches to a modem 33. Typically, the network-user device 31 will communicatively link to a server 50 across network 72. The server 50 will provide network connectives using one or more ports, each port being associated with one or more dialup access numbers. Dialup account information contained in data store 52 can be used by the dialup access system 14 to ascertain an access account of an ISP subscriber telephone 30, or network user device 31, and to provide account authorization. The dialup access system 14 is shown in FIG. 1 communicatively linked to the IVR 42 through network 74, however, it is not necessary for the dialup access system to communicate with the IVR as the present invention determines information about the data communication network 100 (including the dialup access system 14) from IVR messages without the need for direct communication with network components such as the dialup access system 14.

The customer service center 12 can receive calls from an ISP subscriber telephone 30 or a network user device 31 such as a computer 32, pertaining to sales, tech support, network problems, billing, etc. The customer service center 12 can include a customer service agent 40 and an IVR 42 or similar type device defining a network service provider device. The IVR provides an interface 44 to the ISP subscriber 10 via telephone 30 network user device 31. The IVR or network service provider device 42 can be directly linked to the server 50 via network 74. Through this link, the IVR or network service provider device 42 can access information contained in the data store 52. The IVR also has access to data store 90 via network 76 for accessing network and subscriber information at the NOC 18.

The IVR or network service provider device 42 can be a system that accepts a combination of voice telephone input and/or from a telephone and touch-tone keypad 30 input. Additionally, the IVR or network service provider device 42 can receive input directly from the network-user device 31. The IVR or network service provider device 42 also can provide appropriate feedback to an ISP subscriber 10 in the form of voice, fax, callback, e-mail, and other suitable media. In one embodiment, the IVR or network service provider device 42 can be a part of a larger application that includes business rules and database access, such as a customer service database (not shown) that can be included within the customer service center 12. Notably, the IVR or network service provider device 42 can enter a dialogue with the ISP subscriber 10 or network user 10 in real-time. The dialogue can be controlled using a series of pre-established menus 48. Special menu changes can be implemented in response to network events or IVR selections in accordance with business rules as discussed below.

Additionally, the customer service center 12 can be communicatively linked to the NOC 18 via a data connection 22. More specifically, the IVR or network service provider device 42 can be communicatively linked to the external client or controller 82 (hereinafter client) via network 76. The NOC 18 can be a center that provides technical support for one or more dial-up access numbers and network users. The NOC 18 can include one or more live agents 80 and the client 82. In the present example the client 82 is external to the IVR 42.

The client 82 can be one or more communicatively linked computer devices and peripherals that collectively maintain, monitor, and analyze hardware, software, and communication links associated with the dialup access system 14 and ISP subscriber 10. That is, the IVR or network service provider device 42 message sent in route to and from the IVR to client (controller) 82 in NOC can be conveyed to the client controller 82 in real-time. Thus, the client (controller) 82 can responsively initiate a programmatic action in response in real time to the IVR or a network operator.

In one embodiment, the NOC 18 can receive problem indications from multiple sources. These sources can include network monitoring software 84, agents 80, and the IVR user problem reports and IVR actions, time messages received via the IVR or network service provider device 42 and/or a customer service agent 40. The monitoring software 84 can monitor the dialup access system 14 across network 78. The NOC 18 can correlate and combine data from each of these sources to determine a likelihood that a problem exists. Different actions can be taken based upon a set of business rules 200 implemented in client (controller) 82.

As used herein, voice link 20 can be a standard public switched telephone network (PSTN) connection, which is typically a circuit-switched connection. The voice link 20 is not limited in this regard, however, and a packet-based connection that utilizes a technology like Voice over Internet Protocol (VoIP) can also form the voice link 20. The data link 22 can be any communication link capable of digitally conveying information.

Accordingly, networks 70, 72, 74, 76, 78, and 16 can be implemented as any of a variety of fashions so long as content is conveyed using encoded electromagnetic signals. Further, any of a variety of communication devices, such as customer premise equipment (CPE), computers, modems, routers, switches, and similar devices, can be included within networks 70, 72, 74, 76, 78, and 16.

Each of the networks 70, 72, 74, 76, 78, and 16 can convey content in a packet-based or circuit-based manner. Additionally, each of the networks 70, 72, 74, 76, and 78 can convey content via landlines or wireless data communication methods. For example, each of the networks 70, 72, 74, 76, and 78 can separately include an Intranet, a local area network, a wide area network, or a combination thereof. In another example, each of the networks 70, 72, 74, 76, and 78 can include a telephony network, like a mobile wireless network or a public switched telephone network (PSTN). It should be appreciated that the arrangements shown in FIG. 1 are for illustrative purposes only and that the invention is not limited in this regard. The functionality attributable to the various components can be combined or separated in different manners than those illustrated herein. For instance, the network operations center 18 can be integrated with the dialup access system 14 in one embodiment.

The system of business rules 200 for identifying network events and locating actual and potential problems in the network is illustratively implemented as a set of software components configured to be instantiated by the client (controller) 82 at the NOC 18. The system of business rules 200 is communicatively linked to a database 90, the database storing entries generated by the system 200 based upon monitored IVR messages, activities and network communications as explained below. The database 90 may also contain network and subscriber information accessible by the IVR 42.

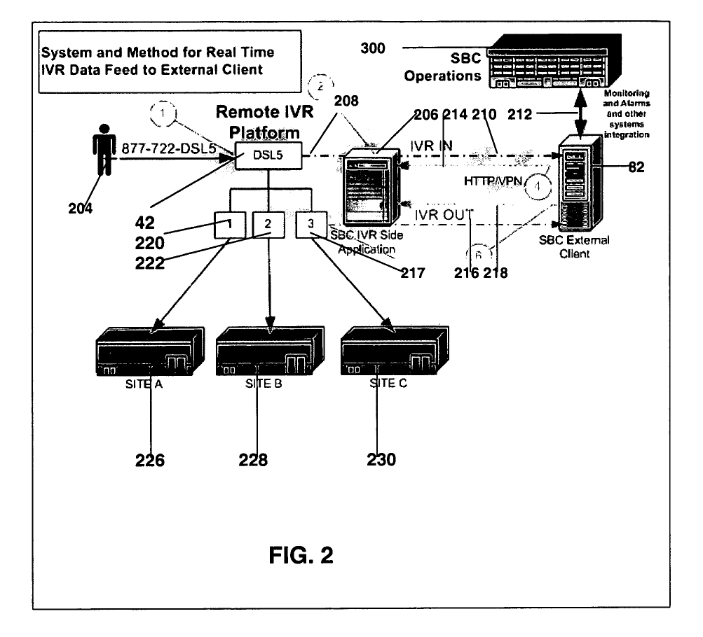

Turning now to FIG. 2, an example of IVR messages sent and received in an operational scenario for the present invention is illustrated. A call 202 placed by caller 204 enters the IVR system 42. The present invention provides an IVR application 206 embedded in the IVR system 42. The IVR application 206 detects IVR inputs and activity. Upon receipt of a call or input at the IVR 42, the IVR application 206 sends an IVR IN message 210 to the external client 82. The external client 82 integrates with other systems 300 as specified by the enterprise. The external client 82 sends an IVR IN acknowledgement 214 to the IVR application 206. The IVR IN acknowledge message may include with possible treatment codes describing how the IVR should treat the call. When the IVR system 42 is ready to release the call to a customer support center telephone number (indicative of but not limited to, sales, billing, new service, cancel service, technical support, etc.), the embedded IVR application 206 sends an IVR OUT message 216 to the external client 82 with additional information regarding the IVR call outcome. The call outcome includes but is not limited to the telephone number to which the call was redirected and the type of IVR disconnect (voluntary, involuntary). The external client 82 acknowledges receipt of the IVR OUT message 216 sending an IVR OUT acknowledge message 218 to the IVR application 206. The call may be transferred, for example, but not limited to a sales call center 226, a technical support call center 228 and a billing call center 230.

An IVR OUT message is sent to the client upon release or disconnect of an IVR call or contact. The IVR OUT message provides additional information about the nature of what occurred during with the IVR contact, including contact type, IVR selections, intended destination, call disposition, whether the IVR timed out or caller self disconnected, contact duration, etc. An IVR IN or IVR OUT message is sent for each IVR activity (call, selection or disconnect type). The selections and disconnect types can be used to characterize whether IVR disconnects appear normal or whether the IVR is exhibiting aberrant behavior such as involuntary disconnects during normal IVR selections and needs attention. If aberrant IVR behavior is detected by a business rule, the network provided is notified to address the potential IVR problem.

Any number and type of data elements may be included within each IVR message, each with any number of specific attributes. Any form of data connectivity can be used to communicate between the IVR application and client, such as HTTP, HTTPs, VPN, Dedicated Frame Relay, etc., or data can be preset to send in batch over FT, SCP etc., if desired.

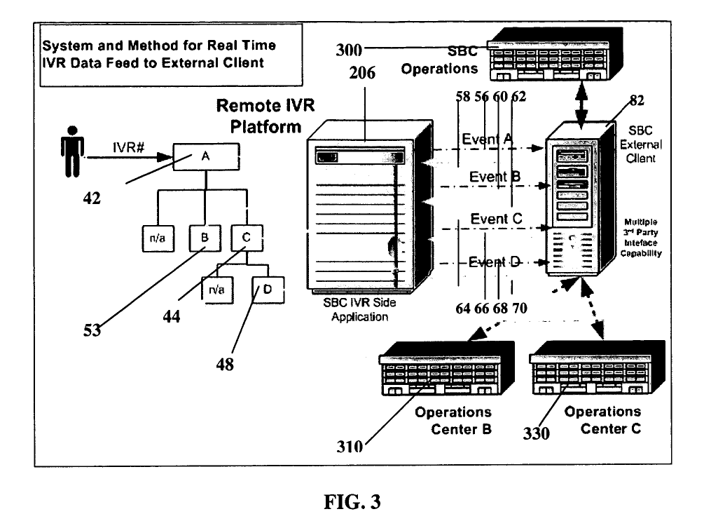

Turning now to FIG. 3, when an IVR call 202 enters the IVR 42, the IVR application 206 detects the IVR contact 51 and alerts the client application by sending an IVR IN message 60 to the client 82. The external client 82 communicates with an external system 300 and returns a response 58 to IVR application 206. Each time an IVR activity, call or selection (51, 53, 42, 48) is made or an IVR action is performed (for example but not limited to a voluntary or involuntary disconnect of the call from the IVR), the IVR application senses the IVR activity, call or selection and sends an IVR message (56, 60, 64, 68) to the external client reporting the IVR activity. Thus a series of IVR selections 51, 53, 42 and 48 are sensed and reported to the external client via messages 56, 60, 64 and 68 respectively. Each IVR message 56, 60, 64 and 68 is acknowledged and responded to by a corresponding acknowledgement or response 58, 62, 66 and 70 respectively. Each acknowledgement and response contains a treatment code and data relating to the IVR activity. The IVR client 82 can communicate with multiple external systems 300, 310 and 330.

The present invention can send multiple messages per call based on various occurrences within the IVR. In such cases the client can also return relevant data to the IVR specific to the caller's current actions within the IVR. For example, refereeing to FIG. 3, if a IVR call comes in 51 and the caller then selects sales 44, and then service cancellation 48 rather than new service 53, a business rule programmed to review the user's account and depending on payment status being current, may offer a discount (for example, a free month of service) to the IVR caller in an attempt avert the cancellation of service and reduce the churn rate. The business rule may also consider the caller's account status based on the ANI and IVR call context, such as a cancellation request during a network outage and recommend appropriate action such as offering the discount to continue service rather than canceling service.

The client side application can act as a relay point where one or more third parties exist, and interact with systems external to the IVR or the client, and relay information back to the IVR. Additionally, the IVR side application can be configured to interact directly with multiple external clients. The external client or clients targeted by the IVR application is configurable by the business. Communication can be XML, Java, VXML or any current or proprietary format. The embedded IVR application and IVR system can be controlled by the client remotely over the same connection used to transfer the IVR call, traffic and IVR selection data. The IVR application can be configured to send summary data instead of or in addition to call-by call data if desired by the business, and can also be specified to trigger from business rules regarding certain IVR events or thresholds, also configurable by the client. For example, a business rule may set a threshold of 50 calls to technical support from the same email domain name. When the 50 call threshold is exceed, the client sends an alert to the network service provider that there may be a problem with the network associated with the email domain equipment.

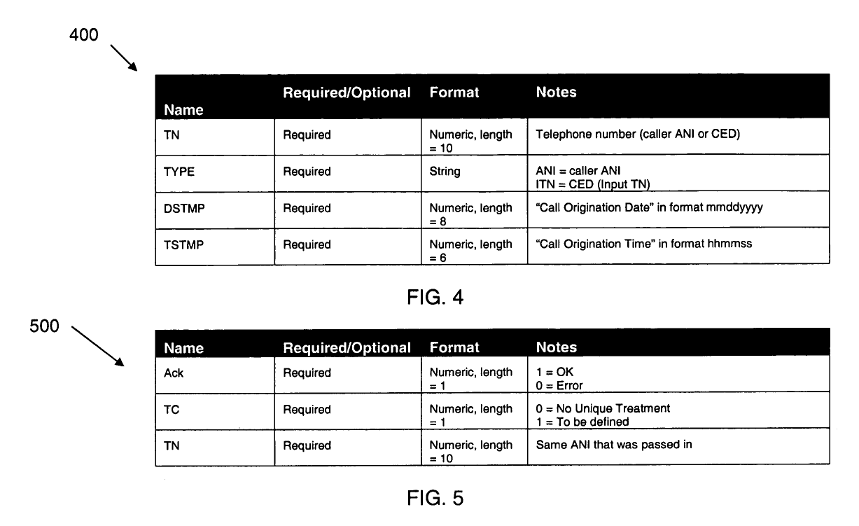

Examples of format and content for an IVR IN, IVR IN acknowledge, IVR OUT and IVR OUT acknowledge messages (IVR messages) are shown in FIG. 4, 5, 6 and 7 respectively. The formats and content illustrated for the IVR messages in FIGS. 4-7 are not mandatory, nor required, as any agreed upon format is suitable for the IVR messages. The IVR IN message is sent to the external client with origination information about the IVR input as soon as a call or IVR selection is received at the IVR platform. This enables the external client 82 to become aware of the IVR, input or activity within milliseconds after a call or IVR selection or activity occurs at the IVR. The external client 82 then sends an acknowledgement response of the request back to the IVR application 206. The acknowledgement response may include additional parameters that can affect the flow of the call or instruct or inform one or more IVR callers via an IVR announcement. A response can include but is not limited to data specific to the account belonging to the caller 204 with whom the call to the IVR is associated or a more general response such as an ambush message in response to a network outage.

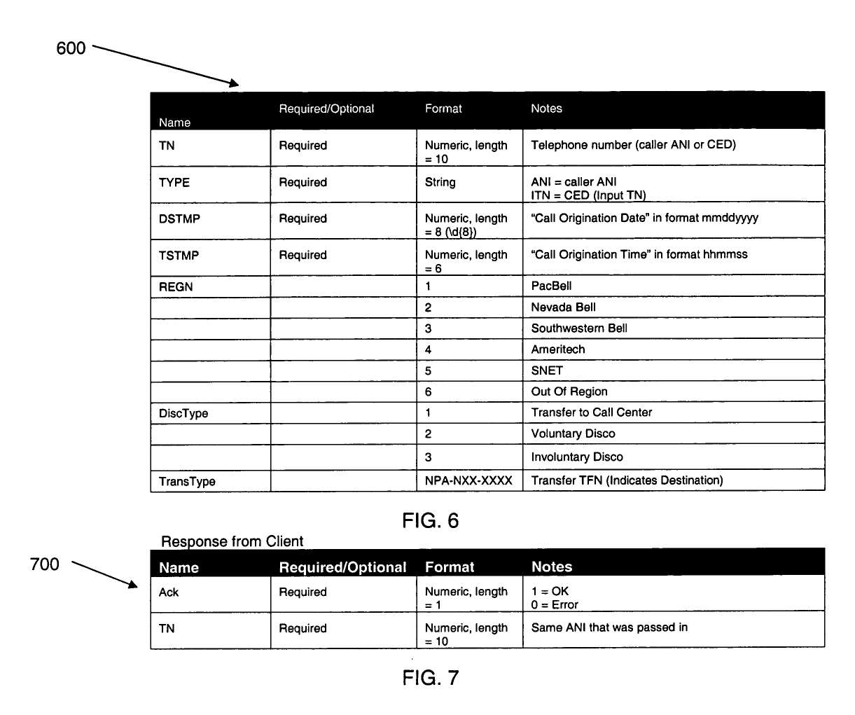

As shown in FIG. 4, an IVR IN message 400 may contain, but is not limited to the following fields and associated data: telephone number (caller ANI); input telephone number; call origination date and call origination time. As shown in FIG. 5, an IVR IN acknowledge message 500 may contain, but is not limited to the following fields and associated data: error/OK; treatment code (TC) and ANI passed into the IVR. As shown in FIG. 6, an IVR OUT message 600 may contain, but is not limited to the following fields and associated data: telephone number (TN); ANI; call origination date, call origination time; region (RGN); disconnect type (transfer to call center, voluntary disconnect, involuntary disconnect) and transfer destination telephone number. As shown in FIG. 7, an IVR OUT acknowledge message 700 may contain, but is not limited to the following fields and associated data: OK/error and ANI passed into the IVR.

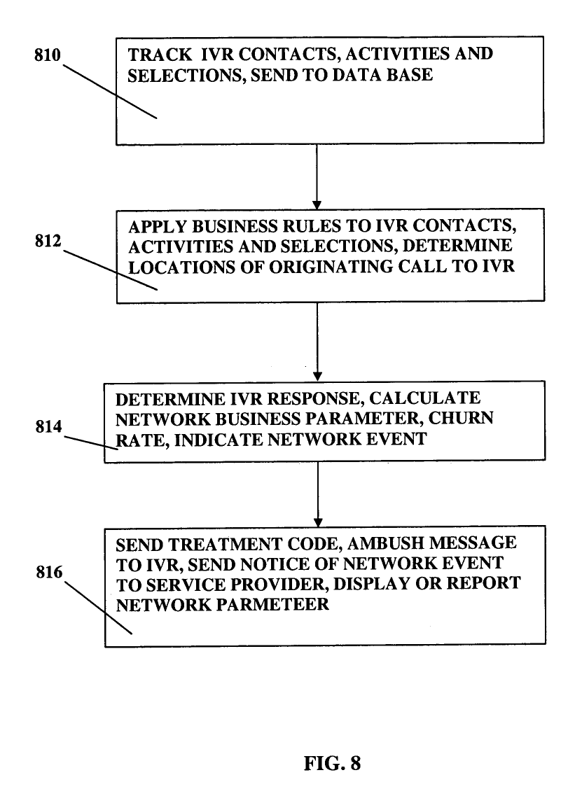

Turning now to FIG. 8 a flow chart of functions provided by the present invention is illustrated. In block 810 the present invention monitors IVR contacts, activities and selections that take place between any of the network-user devices 31 and the IVR or network service provider device 42 in real time. The IVR or network service provider device 42 can accept a voice telephone input and/or touch-tone keypad input as well as direct input from the network-user device 31. Therefore, it follows that an IVR IN message can correspond to a communication including an IVR selection from a user via one or more modes of reporting an actual and potential network problem.

Optionally, the system and method can further include a database-generating module 225 that generates entries for database 90 based upon the tracked network communications. The database 90 is linked to the client 82 on which the system is illustratively configured to run. The database 90 provides a source of data derived from the tracked network communications, the data being usable by the business rules to analyze actual and potential network problems and events.

As shown in block 812, the present invention applies business rules to monitored IVR contacts, activities and selections to determine an appropriate IVR response. The IVR 42 or network service provider device can be configured to also provide interactive feedback to a user in the form of voice, fax, callback, e-mail, and other suitable media. Accordingly, an IVR response can also pertain to a network service provider's response to a network user's input to the IVR including a report of an actual or potential network problem. More particularly, therefore, a network communication can correspond to a call from the at least one network-user device to the IVR 42 and/or call from a network service provider's technical support unit or operation (not shown) at, for example, the NOC 18. By tracking one or both of these types of communications, the present invention can determine a corresponding number of network communications that pertain to IVR contacts, activities and provides selections.

The system and method provides a location-indicating function to indicate a location of the network-user device. The location indicating function, using the indicated location of the network-user device, can correlate the location with a part of the network exhibiting a tracked characteristic, such as an actual or potential network problem. More particularly, the network-user device can be identified, for example, by call detail data that includes an ANI for the network-user device. As will be readily appreciated by one of ordinary skill in the art, the ANI is typically available in real-time or near real-time through a long-distance or other type of carrier. Accordingly, in one embodiment, the ANI is run against one or more internal databases to determine the network nodes and/or network elements to which the ANI maps. Thus, the location function can use ANI data to determine locations of actual or potential network problems.

As shown in block 814 the present invention determines an appropriate IVR response. Network parameters such as real time churn rate can be calculated and displayed or reported based on the number of IVR calls and selections to cancel service versus the number of VIR calls and selection to sales to connect new service. The real time churn rate can be displayed as a running total or graphic representation of total system subscribers versus time, displayed on a graphic user interface (GUI) at computer 88. The IVR response, for example, can correspond to IVR calls, count, call types, call out, etc. IVR actions can comprise data pertaining to a call or other network communication to the IVR or network service provider device 42 and/or a call or other network communication from the technical support unit or operation.

As shown in block 816, the present invention monitors the IVR activity to determine and respond with an appropriate treatment code such as an ambush message or network event notice to be announced to subsequent callers to the IVR system. The present invention also provides a network advisor function in the client to notify a network provider of a network event. The treatment code is based upon the number of network communications that pertain to selected IVR activity, call type or call disposition and to actual or potential network problems tracked. Programmable business rules are provided to determine whether the number of IVR calls or particular IVR selection types exceed a predetermined threshold. The system and method of the present invention renders one or more graphical user interfaces (GUIs) that are illustratively displayed on the monitor of a computer 88 connected to the controller 82. Alternatively, the GUIs can be displayed on any device capable of rendering a visual image and connected to the client 82.

Although the system and method of the present invention has been described in terms of software configured to run on the client 82, it will be readily appreciated by those of ordinary skill in the art that the system and method alternately can be implemented with hardwired circuitry comprising processing and memory storing capabilities. Such circuitry can comprise, for example, one or more logic gates and one or more memory components. Alternatively, the system and method of the present invention can be implemented as a combination of the software modules and hardwired circuitry.

The system and method can be implemented in software-based modules and/or in one or more hardwired circuits. Accordingly, the present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What claimed is:

1. A computerized method for monitoring an interactive voice response system (IVR) in real time, comprising:
detecting an IVR activity; and
sending an IVR message to a client in substantially real time upon detecting the IVR activity.

2. The method of claim 1, further comprising:
applying a business rule to the IVR message; and
sending a response in real time to the IVR message from the client to the IVR including a treatment code.

3. The method of claim 1, further comprising:
determining a network event from the IVR message; and
sending a message to a service provider indicating the occurrence of the network event.

4. The method of claim 1, further comprising:
determining a network event from at least one IVR message; and
sending a response to the IVR addressing the network event.

5. The method of claim 4, wherein the response includes an ambush message to address a network event.

6. The method of claim 4, wherein the response includes a user offer.

7. The method of claim 4, wherein the response includes a message specific to a user associated with the IVR activity.

8. The method of claim 2, wherein the business rule comprises calculating a churn rate equal to new service selections minus service cancellation selections.

9. The method of claim 1, wherein the IVR activity includes at least one of an input, selection, call redirection and call disconnect.

10. A computer readable medium containing instructions that when executed by a computer perform a method for monitoring an interactive voice response system (IVR) in real time, comprising:
detecting an IVR activity; and
sending an IVR message to a client in substantially real time upon detecting the IVR activity.

11. The medium of claim 10, the method further comprising:
applying a business rule to the IVR message; and
sending a response to the IVR message from the client to the IVR including a treatment code.

12. The medium of claim 10, the method further comprising:
determining a network event from at least one IVR message; and
sending a message to a service provider indicating the occurrence of the network event.

13. The medium of claim 10, the method further comprising:
determining a network event from at least one IVR message; and
sending a response to the IVR addressing the network event.

14. The medium of claim 13, wherein in the method the response includes an ambush message to address a network event.

15. The medium of claim 13, wherein in the method the response includes a user offer.

16. The medium of claim 13, wherein in the method the response includes a message specific to a user associated with the IVR activity.

17. The medium of claim 11, wherein in the method the business rule comprises calculating a churn rate equal to new service selections minus service cancellation selections.

18. The medium of claim 10, wherein in the method the IVR activity includes at least one of an input, selection, call redirection and call disconnect.

19. A real time monitoring system for an interactive recognition system (IVR) system comprising:
an IVR processor programmed to send an IVR message in real time upon detection of IVR activity; and
a client processor for receiving the IVR message.

20. The system of claim 19, wherein the client processor is programmed to send a response in to the IVR processor.

21. The system of claim 19, wherein the client processor is programmed to determine a network event from the IVR message and send a message to a network service provider indicating the occurrence of the network event.

22. The system of claim 19, wherein the client processor is programmed to determine a network event from the IVR message and send a response to the IVR processor indicating occurrence of the network event.

23. The system of claim 20, wherein the response includes a user offer.

24. The system of claim 22, wherein the response includes an ambush message to address a network event.

25. The system of claim 19, wherein the client is programmed to apply a business rule to the IVR message.

26. The system of claim 25, wherein the business rules includes calculation of a churn rate equals new service selections minus service cancellation selections.

27. The system of claim 19, wherein the IVR activity includes at least one of an input, selection, call redirection and call disconnect.

28. A real time monitoring system for an interactive recognition system (IVR) system comprising:
a communication network including an IVR processor programmed to send an IVR message in real time upon detection of IVR activity; and
a client processor for receiving the IVR message.
